(19) United States
(12) Patent Application Publication
(10) Pub. No.: US 2024/0386536 A1
(43) Pub. Date: Nov. 21, 2024

(54) IMAGING SYSTEM, PROCESSING DEVICE, AND MACHINE LEARNING DEVICE

(71) Applicant: Sony Semiconductor Solutions Corporation, Atsugi-shi, Kanagawa (JP)

(72) Inventor: Ryo YASUDA, Tokyo (JP)

(73) Assignee: Sony Semiconductor Solutions Corporation, Atsugi-shi, Kanagawa (JP)

(21) Appl. No.: 18/689,878

(22) PCT Filed: Mar. 9, 2022
(86) PCT No.: PCT/JP2022/010416

§ 371 Date: Mar. 7, 2024

(30) Foreign Application Priority Data
Sep. 17, 2021 (JP) 2021-151822

(51) Int. Cl. G06T 5/73; G06T 5/50; G06V 10/75

(52) U.S. Cl. CPC G06T 5/73; G06T 5/50; G06V 10/751; G06T 2207/20224

(57) ABSTRACT

An imaging system includes an imaging unit that generates two captured images by performing an imaging operation at a set shutter speed at mutually different imaging timings; an image processing unit that generates a differential image of the two captured images; a first generator that calculates, in each of a plurality of image regions divided in the differential image, a number of pixels having a pixel value higher than a predetermined value among a plurality of pixels in the image region, and generates map data indicating a result of such calculation; a storage unit that stores a learning model to which shutter data indicating the shutter speed, captured image data representing one of the two captured images, and the map data are inputted and from which image data corresponding to the captured image data is outputted; and circuitry that generates the image data using the learning model.

### TECHNICAL FIELD

The present disclosure relates to an image system that processes a captured image obtained by performing an imaging operation, using a learning model; a processing device that processes the captured image, using the learning model; and a machine learning device that generates such a learning model.

### BACKGROUND ART

There are some imaging devices, such as cameras, that attempt to improve image quality of a captured image using AI (artificial intelligence). For example, PTL 1 discloses an imaging device that reduces noise in a captured image using a neural network.

### CITATION LIST

### Patent Literature

PTL 1: Japanese Unexamined Patent Application Publication No. 2020-57373

### SUMMARY OF THE INVENTION

In fact, for example, in a case where an object is a moving body or in a case where an image is captured with an imaging device held in hand, an image may be slightly blurred. It is desirable to reduce such image blur.

It is desirable to provide an imaging system, a processing device, and a machine learning device that make it possible to effectively reduce image blur.

An imaging system according to an embodiment of the present disclosure includes an imaging unit, an image processing unit, a first generator, a storage unit, and a calculation unit. The imaging unit is configured to generate two captured images by performing an imaging operation at a set shutter speed at mutually different imaging timings. The image processing unit is configured to generate a differential image of the two captured images. The first generator calculates, in each of a plurality of image regions divided in the differential image, a number of pixels having a pixel value higher than a predetermined value among a plurality of pixels in the image region, and is thereby configured to generate map data indicating a result of such calculation. The storage unit is configured to store a learning model to which shutter data indicating the shutter speed, captured image data representing one of the two captured images, and the map data are inputted and from which image data corresponding to the captured image data is outputted. The calculation unit is configured to generate the image data using the learning model, on the basis of the shutter data, the captured image data, and the map data.

A processing device according to an embodiment of the present invention includes a first generator, a storage unit, and a calculation unit. The first generator calculates, in each of a plurality of image regions divided in a differential image of two captured images, a number of pixels having a pixel value higher than a predetermined value among a plurality of pixels in the image region, and is thereby configured to generate map data indicating a result of such calculation. The two captured images are generated by performing an imaging operation at a set shutter speed at mutually different imaging timings. The storage unit is configured to store a learning model to which shutter data indicating the shutter speed, captured image data representing one of the two captured images, and the map data are inputted and from which image data corresponding to the captured image data is outputted. The calculation unit is configured to generate the image data using the learning model, on the basis of the shutter data, the captured image data, and the map data.

A machine learning device according to an embodiment of the present disclosure includes a data acquisition unit, a teacher data acquisition unit, a second generator, and a learning processing unit. The data acquisition unit is configured to acquire captured image data, differential image data, and shutter data. The captured image data represents one of two captured images generated by performing an imaging operation at a set shutter speed at mutually different imaging timings. The differential image data represents a differential image of the two captured images. The shutter data indicates the shutter speed. The teacher data acquisition unit is configured to acquire image data corresponding to the captured image data. The second generator calculates, in each of a plurality of image regions divided in the differential image, a number of pixels having a pixel value higher than a predetermined value among a plurality of pixels in the image region, on the basis of the differential image data, and is thereby configured to generate map data indicating a result of such calculation. The learning processing unit is configured to generate a learning model to which the shutter data, the captured image data, and the map data are inputted and from which the image data is outputted, by performing machine learning processing using the shutter data, the captured image data, the map data, and the image data.

In the imaging system according to the embodiment of the present disclosure, the imaging unit generates the two captured images by performing the imaging operation at the set shutter speed at the mutually different imaging timings. The image processing unit generates the differential image of the two captured images. The first generator generates the map data on the basis of the differential image. The map data is data indicating the number of pixels having the pixel value higher than the predetermined values in each of the plurality of image regions divided in the differential image, among the plurality of pixels in the image region. Then, the calculation unit generates the image data corresponding to the captured image data using the learning model, on the basis of the shutter data indicating the shutter speed, the captured image data representing one of the two captured images, and the map data.

In the processing device according to the embodiment of the present disclosure, the first generator generates the map data on the basis of the differential image of the two captured images generated by performing the imaging operation at the set shutter speed at the mutually different imaging timings. The map data is data indicating the number of pixels having the pixel value higher than the predetermined values in each of the plurality of image regions divided in the differential image, among the plurality of pixels in the image region. Then, the calculation unit generates the image data corresponding to the captured image data using the learning model, on the basis of the shutter data indicating the shutter speed, the captured image data representing one of the two captured images, and the map data.

In the machine learning device according to the embodiment of the present disclosure, the data acquisition unit acquires the captured image data representing one of the two captured images generated by performing the imaging operation at the set shutter speed at the mutually different imaging timing; the differential image data representing the differential image of the two captured images; and the shutter data indicating the shutter speed. The teacher data acquisition unit acquires the image data corresponding to the captured image data. The second generator generates the map data on the basis of the differential image. The map data is data indicating the number of pixels having the pixel value higher than the predetermined values in each of the plurality of image regions divided in the differential image, among the plurality of pixels in the image region. Then, the learning processing unit performs the machine learning processing using the shutter data, the captured image data, the map data, and the image data to thereby generate the learning model to which the shutter data, the captured image data, and the map data are inputted and from which the image data is outputted.

### BRIEF DESCRIPTION OF DRAWING

FIG. 1 is a block diagram illustrating a configuration example of an imaging device according to an embodiment of the present disclosure.

FIG. 2 is an explanatory diagram illustrating an operation example of a differential image generator illustrated in FIG. 1.

FIG. 3 is an explanatory diagram illustrating an operation example of a motion data generator 14 illustrated in FIG. 1.

FIG. 4 is an explanatory diagram illustrating an example of input data and output data of a learning model illustrated in FIG. 1.

FIG. 5 is a block diagram illustrating a configuration example of a machine learning device that generates the learning model illustrated in FIG. 1.

FIG. 6 is a flowchart illustrating an operation example of the imaging device illustrated in FIG. 1.

FIG. 7 is an explanatory diagram illustrating one example of a differential image.

FIG. 8 is an explanatory diagram illustrating another example of the differential image.

FIG. 9 is an explanatory diagram illustrating another example of the differential image.

FIG. 10 is an explanatory diagram illustrating an example of input data and output data of a learning model in a case where an object remains still.

FIG. 11 is a flowchart illustrating an operation example of the machine learning device illustrated in FIG. 5.

FIG. 12 is a block diagram illustrating a configuration example of an imaging device according to a modification example.

FIG. 13 is a block diagram illustrating a configuration example of an imaging system according to another modification example.

FIG. 14A is an explanatory diagram illustrating an operation example of an imaging unit according to another modification example.

FIG. 14B is an explanatory diagram illustrating an example of input data and output data of the learning model according to the other modification example.

FIG. 15 is an explanatory diagram illustrating an operation example of an imaging device according to another modification example.

FIG. 16 is a block diagram illustrating a configuration example of the imaging device according to another modification example.

FIG. 17 is an explanatory diagram illustrating one example of input data and output data of the learning model illustrated in FIG. 16.

FIG. 18 is a block diagram illustrating one example of a machine learning device that generates the learning model illustrated in FIG. 16.

FIG. 19 is a perspective view of one example of an appearance configuration of a smartphone according to an application example.

### MODES FOR CARRYING OUT THE INVENTION

In the following, some embodiments of the present disclosure will be described in detail with reference to the drawings. It is to be noted that the description will be given in the following order:
1. Embodiments
2. Application Example

### 1. Embodiments

### [Configuration Examples]

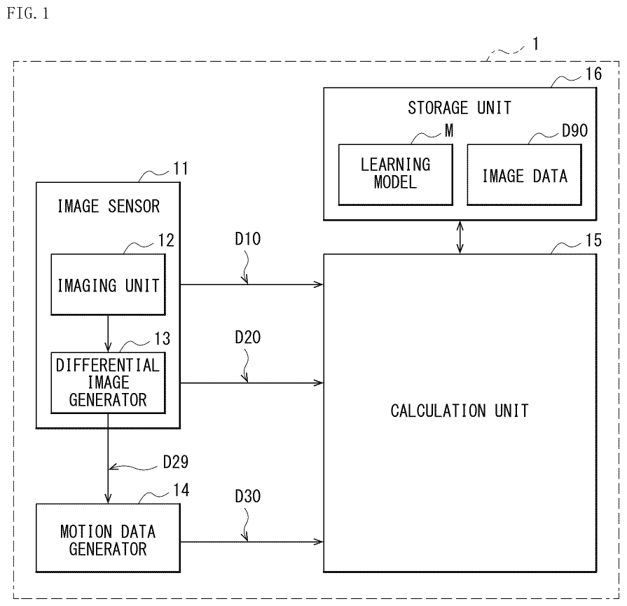

FIG. 1 illustrates a configuration example of an imaging device (imaging device 1) according to one embodiment. The imaging device 1 is, for example, a camera or a smartphone with an imaging function. The imaging device 1 includes an image sensor 11, a motion data generator 14, a calculation unit 15, and a storage unit 16.

The image sensor 11 is configured using, for example, a CMOS (Complementary Metal Oxide Semiconductor) sensor, and is configured to image an object. The image sensor 11 has an imaging unit 12 and a differential image generator 13.

The imaging unit 12 is configured to generate captured images by performing an imaging operation. The imaging unit 12 generates two captured images by performing an imaging operation at a set shutter speed at mutually different imaging timings.

The differential image generator 13 is configured to generate a differential image of the two captured images generated by the imaging unit 12.

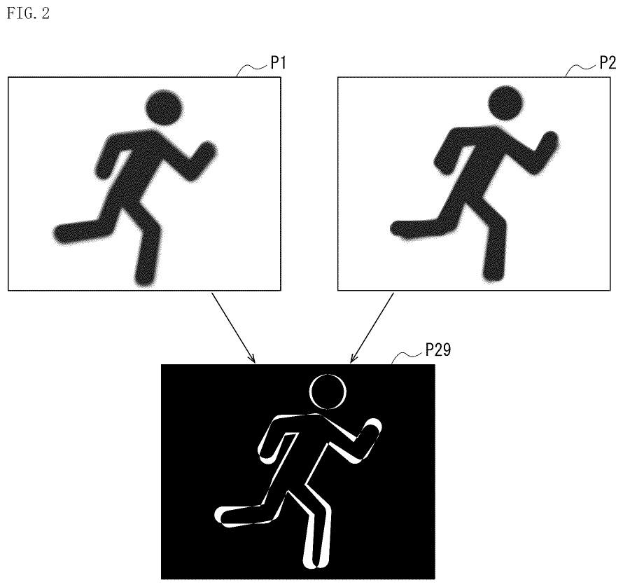

FIG. 2 illustrates an operation example of the differential image generator 13. The differential image generator 13 is supplied with two captured images P1 and P2 from the imaging unit 12. The captured image P1 is generated by the imaging operation at a first imaging timing, and the captured image P2 is generated by the imaging operation at a second imaging timing that is after the first imaging timing. In this example, an object is a person who is running. In this example, because the object does not remain still and the shutter speed is not set to a very fast speed, the captured images P1 and P2 are slightly blurred. Image blur in response to motion of an object is also called motion blur. In addition, because the object is moving during time that corresponds to an imaging interval between the first imaging timing and the second imaging timing, the captured image P1 and the captured image P2 differ from each other.

In this manner, the differential image generator 13 generates a differential image P29 of the two captured images P1 and P2 that are mutually different. Specifically, the differential image generator 13 calculates respective differential values between a plurality of pixel values in the captured image P1 and a plurality of pixel values in the captured image P2, thereby generating the differential image P29. In the differential image P29 illustrated in FIG. 2, a black portion denotes that the differential value is “0” and a white portion denotes that the differential value is large. In this example, because the person who is the object is running, the differential value is large near the object's arms or legs where the motion is fast. The differential image generator 13 generates the differential image P29 including such differential values as pixel values.

In this manner, the image sensor 11 images the object. Then, the image sensor 11 supplies, to the calculation unit 15, shutter data D10 indicating the shutter speed in the imaging operation and captured image data D20 representing the second captured image P2 of the two captured images P1 and P2. In addition, the image sensor 11 supplies, to the motion data generator 14, differential image data D29 representing the differential image P29 generated by the differential image generator 13.

The motion data generator 14 (FIG. 1) is configured to generate motion data D30 on the basis of the differential image data D29.

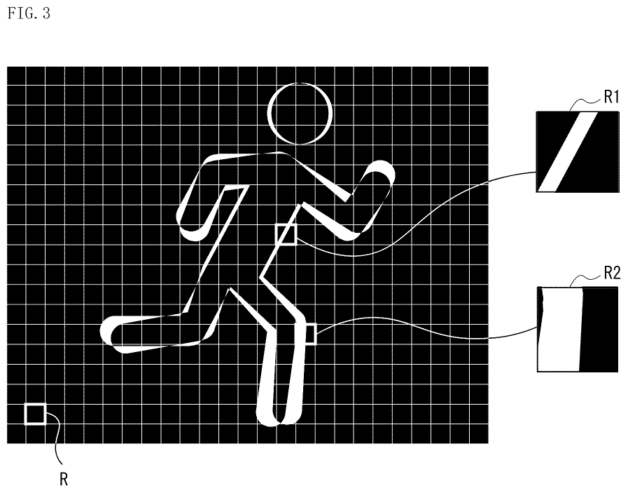

FIG. 3 illustrates an operation example of the motion data generator 14. The motion data generator 14 first divides the differential image P29 represented by the differential image data D29 into a plurality of image regions R. The differential image P29 is divided, for example, into approximately 30 pieces in a lateral direction and approximately 30 pieces in a longitudinal direction. Then, the motion data generator 14 calculates, in each of the plurality of divided image regions R, a number of pixels having a pixel value (differential value) higher than a predetermined value among a plurality of pixels in the image region R, thereby generating the motion data D30 that indicates the calculation result. For example, in an image region R (image region R1) near the object' chest, the object's motion is slow, and thus the white portion has a small area. That is, in the image region R1, there are a small number of pixels having the pixel value (differential value) higher than the predetermined value. In addition, the object's motion is fast in an image region R (image region R2) near the object's legs, for example, and thus the white portion has a large area. That is, in the image region R2, there are many pixels having the pixel value (differential value) higher than the predetermined value. The motion data generator 14 calculates, in each of the plurality of divided pixel regions R, the number of pixels having the pixel value (differential value) higher than the predetermined value among the plurality of pixels in that image region R, thereby generating the motion data D30 that is map data indicating the calculation result. Then, the motion data generator 14 supplies the motion data D30 to the calculation unit 15.

The calculation unit 15 (FIG. 1) is configured to generate image data D90 using a learning model M, on the basis of the shutter data D10 and the captured image data D20 supplied from the image sensor 11 as well as the motion data D30 supplied from the motion data generator 14. The learning model M is configured using a neural network model, for example, and has an input layer, one or more intermediate layers, and an output layer.

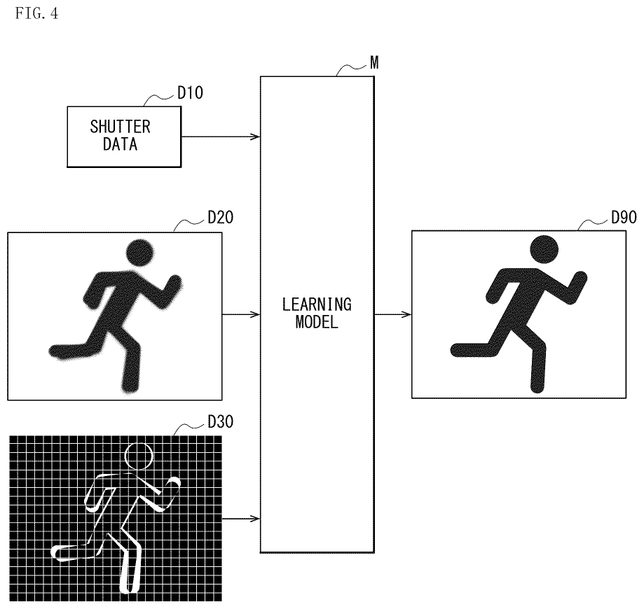

FIG. 4 illustrates an example of input data and output data of the learning model M. It is to be noted that in this FIG. 4, the motion data D30 is denoted using the differential image P29 that is divided into the plurality of image regions R. The learning model M is such configured that the shutter data D10, the captured image data D20, and the motion data 30 are inputted to the learning model M and the image data D90 is outputted from the learning model M. An image represented by the image data D90 is an image where blur has been reduced on the basis of an image represented by the captured image data D20.

In this manner, using the learning model M, the calculation unit 15 is able to generate the image data D90 representing the image with reduced blur on the basis of the shutter data D10, the captured image data D20, and the motion data D30. The motion data generator 14 and the calculation unit 15 are configured using, for example, a processor or a RAM (Random Access Memory), or the like.

The storage unit 16 (FIG. 1) is configured using, for example, a non-volatile semiconductor memory. In this example, the storage unit 16 stores the learning model M and the image data D90. The learning model M is generated by a machine learning device 100 to be described below, and is prestored in the storage unit 16. Then, the storage unit 16 supplies the learning model M to the calculation unit 15. In addition, the storage unit 16 stores the image data D90 generated by the calculation unit 15.

Next, a description will be given of the machine learning device 100 that generates the learning model M to be used in the imaging device 1.

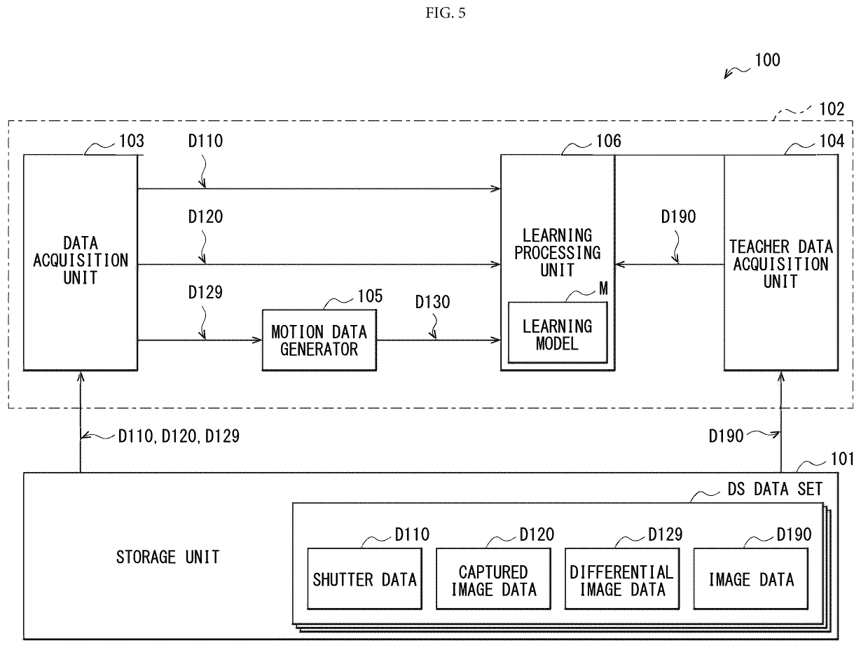

FIG. 5 illustrates a configuration example of the machine learning device 100. The machine learning device 100 is configured using, for example, an information processing device including a personal computer or a server. The machine learning device 100 includes a storage unit 101 and a processing unit 102.

The storage unit 101 is configured using, for example, an SSD (Solid State Drive) or an HDD (Hard Disk Drive), or the like. The storage unit 101 stores a plurality of data sets DS. The plurality of data sets DS is data used in machine learning processing. Each of the plurality of data sets DS includes shutter data D110, captured image data D120, differential image data D129, and image data D190.

Similarly to the shutter data D10, the shutter data D110 is the data indicating the shutter speed in the imaging operation. Similarly to the captured image data D20, the captured image data D120 is the data representing the second captured image of the two captured images generated by performing the imaging operation at different imaging timings that are different from each other. Similarly to the differential image data D29, the differential image data D129 is the data representing the differential image of the two captured images.

The image data D190 includes data of an image that corresponds to the image represented by the captured image data D120 and the data of the image with reduced image blur. The image data D190 is used as teacher data in the machine learning processing. The image data D190 is generated by performing image processing using a publicly known technique for reducing the image blur, for example, on the basis of the captured image data D120. In addition, the image data D190 may be generated, for example, by performing an imaging operation using a high shutter speed.

The processing unit 102 includes a data acquisition unit 103, a teacher data acquisition unit 104, a motion data generator 105, and a learning processing unit 106.

The data acquisition unit 103 is configured to acquire the shutter data D110, the captured image data D120, and the differential image data D129 that are included in a selected data set DS of the plurality of data sets DS stored in the storage unit 101. Then, the data acquisition unit 103 supplies the shutter data D110 and the captured image data D120 to the learning processing unit 106, and supplies the differential image data D129 to the motion data generator 105.

The teacher data acquisition unit 104 is configured to acquire the image data D190 included in the selected data set DS of the plurality of data sets DS stored in the storage unit 101. Then, the teacher data acquisition unit 104 supplies the image data D190 to the learning processing unit 106.

Similarly to the motion data generator 14 (FIG. 1), the motion data generator 105 is configured to generate motion data D130 on the basis of the differential image data D129 supplied from the data acquisition unit 103.

The learning processing unit 106 is configured to generate the learning model M by performing the machine learning processing on the basis of the shutter data D110, the captured image data D120, and the motion data D130, as well as the image data D190 that is the teacher data. The learning processing unit 106 generates the learning model M by performing supervised learning using the neural network model.

Here, the imaging device 1 corresponds to a specific example of the “imaging system” in the present disclosure. The imaging unit 12 corresponds to a specific example of the “imaging unit” in the present disclosure. The differential image generator 13 corresponds to a specific example of the “image processing unit” in the present disclosure. The motion data generator 14 corresponds to a specific example of the “first generator” in the present disclosure. The storage unit 16 corresponds to a specific example of the “storage unit” in the present disclosure. The calculation unit 15 corresponds to a specific example of the “calculation unit” in the present disclosure. The shutter data D10 corresponds to a specific example of the “shutter data” in the present disclosure. The captured image data D20 corresponds to a specific example of the “captured image data” in the present disclosure. The motion data D30 corresponds to a specific example of the “map data” in the present disclosure. The image data D90 corresponds to a specific example of the “image data” in the present disclosure.

The machine learning device 100 corresponds to a specific example of the “machine learning device” in the present disclosure. The data acquisition unit 103 corresponds to a specific example of the “data acquisition unit” in the present disclosure. The teacher data acquisition unit 104 corresponds to a specific example of the “teacher data acquisition unit” in the present disclosure. The motion data generator 105 corresponds to a specific example of the “second generator” of the present disclosure. The learning processing unit 106 corresponds to a specific example of the “learning processing unit” in the present disclosure. The shutter data D110 corresponds to a specific example of the “shutter data” in the present disclosure. The captured image data D120 corresponds to a specific example of the “captured image data” in the present disclosure. The differential image data D129 corresponds to a specific example of the “differential image data” in the present disclosure. The motion data D130 corresponds to a specific example of the “map data” in the present disclosure. The image data D190 corresponds to a specific example of the “image data” in the present disclosure.

### [Operations and Workings]

Next, a description will be given of operations and workings of the imaging device 1 and the machine learning device 100 of the present embodiment.

### (Overview of Overall Operation)

First, a description will be given of an overview of overall operations of the imaging device 1 and the machine learning device 100 with reference to FIGS. 1 and 5. In the imaging device 1, the imaging unit 12 of the image sensor 11 generates two captured images by performing the imaging operation. The differential image generator 13 generates a differential image of the two captured images generated by the imaging unit 12. The image sensor 11 supplies, to the calculation unit 15, the shutter data D10 indicating the shutter speed in the imaging operation and the captured image data D20 representing the second captured image of the two captured images. The image sensor 11 also supplies, to the motion data generator 14, the differential image data D29 representing the differential image generated by the differential image generator 13. The motion data generator 14 generates the motion data D30 on the basis of the differential image data D29. The calculation unit 15 generates the image data D90, using the learning model M, on the basis of the shutter data D10 and the captured image data D20 supplied from the image sensor 11 as well as the motion data D30 supplied from the motion data generator 14. The storage unit 16 stores the learning model M and the image data D90.

In the machine learning device 100, the storage unit 101 stores the plurality of data sets DS. In the processing unit 102, the data acquisition unit 103 acquires the shutter data D110, the captured image data D120, and the differential image data D129 that are included in the selected data set DS of the plurality of data sets DS stored in the storage unit 101. The teacher data acquisition unit 104 acquires the image data D190 that is included in the selected data set DS of the plurality of data set DS stored in the storage unit 101. The motion data generator 105 generates the motion data D130 on the basis of the differential image data D129 supplied from the data acquisition unit 103. The learning processing unit 106 generates the learning model M by performing the machine learning processing on the basis of the shutter data D110, the captured image data D120, and the motion data D130, as well as the image data D190 that is the teacher data.

### (Detailed Operation)

In the following, a detailed description will be given of the operations of the imaging device 1 and the machine learning device 100 in this order.

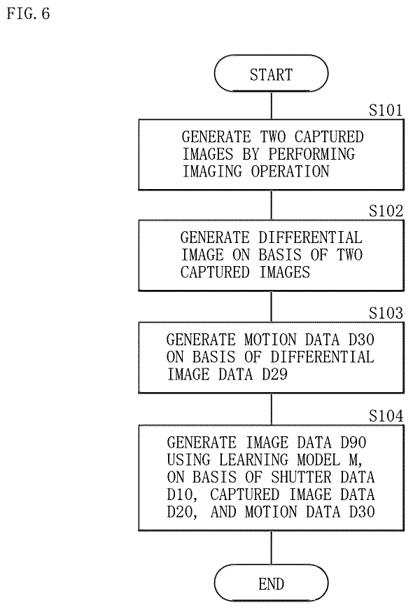

FIG. 6 illustrates an operation example of the imaging device 1.

First, the imaging unit 12 of the image sensor 11 generates two captured images by performing the imaging operation (step S101). Specifically, the imaging unit 12 generates the two captured images by performing the imaging operation at the set shutter speed at mutually different imaging timings.

Next, the differential image generator 13 of the image sensor 11 generates a differential image of the two captured images generated by the imaging unit 12 (step S102). Specifically, as illustrated in FIG. 2, the differential image generator 13 generates the differential image by calculating respective differential values between a plurality of pixel values in the first captured image and a plurality of pixel values in the second captured image.

Next, the motion data generator 14 generates the motion data D30 on the basis of the differential image data D29 representing the differential image generated by step S102 (step S103). Specifically, as illustrated in FIG. 3, the motion data generator 14 calculates, in each of the plurality of divided pixel regions R, the number of pixels having the pixel value higher than the predetermined value among the plurality of pixels in the image region R, thereby generating the motion data D30 indicating the calculation result.

Next, the calculation unit 15 generates the image data D90 using the learning model M on the basis of the shutter data D10 indicating the shutter speed in the imaging operation performed in step S101, the captured image data D20 representing the second captured image of the two captured images generated in step S101, and the motion data D30 generated in the step S103 (step S104).

Thus, the flow ends.

In this manner, the calculation unit 15 is able to generate the image data D90 representing the image with reduced blur, by correcting the image represented by the captured image data D20 using the learning model M, on the basis of the shutter data D10, the captured image data D20, and the motion data D30. That is, in this example, in the captured image represented by the captured image data D20, blur occurs due to the object moving in exposure time corresponding to the shutter speed. The shutter data D10 includes information regarding a length of the exposure time, and the motion data D30 includes information regarding movement of the object.

That is, the shutter data D10 is the data indicating the shutter speed. For example, a slow shutter speed indicates that the exposure time is long, and a fast shutter speed indicates that the exposure time is short. Thus, the shutter data D10 includes the information regarding the exposure time.

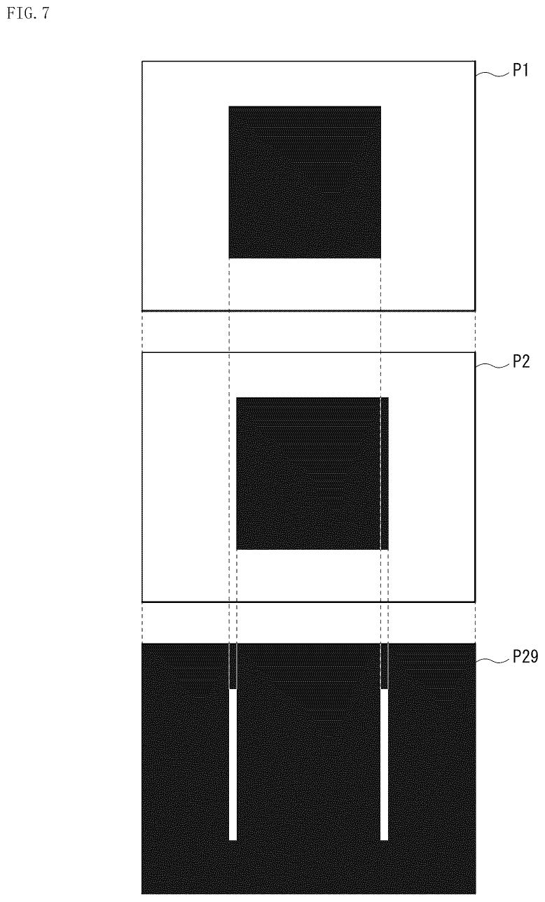

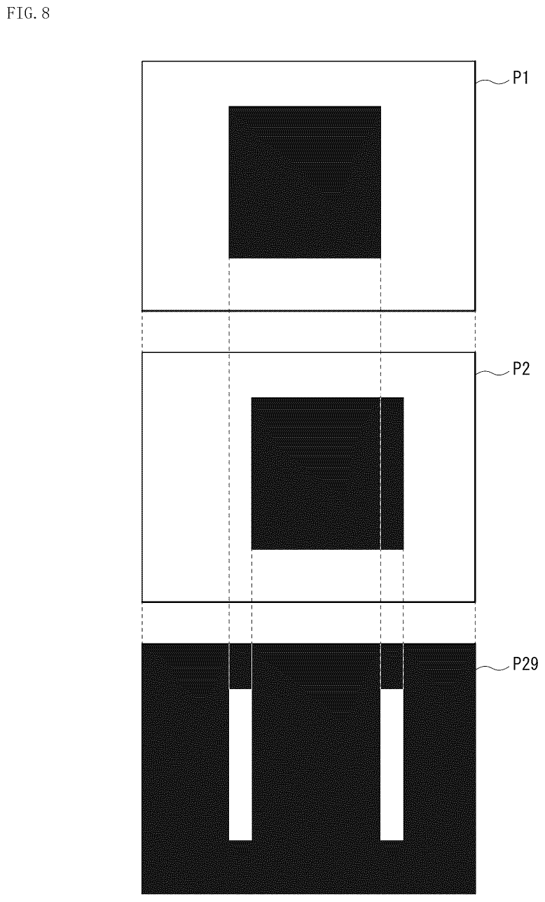

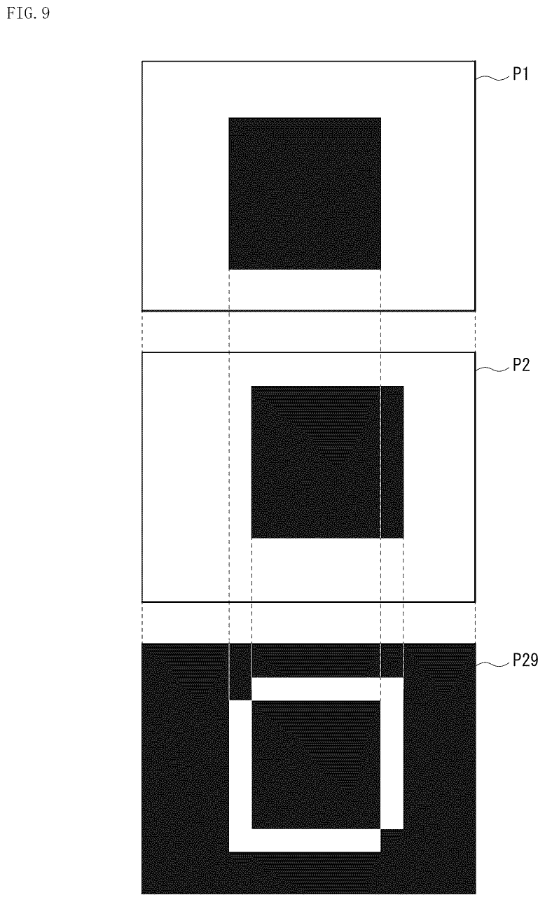

In addition, the motion data D30 includes the information regarding the movement of the object in each of the plurality of divided image regions R. For example, as illustrated in FIGS. 7 and 8, in a case where the object moves laterally from left to right, in the differential image P29, a portion depicted in white where the differential value is large is generated near the object's left end and right end. In addition, as illustrated in FIG. 9, in a case where the object moves diagonally from lower left to upper right, in the differential image P29, the portion depicted in white where the differential value is large is generated near the object's lower left end and right end. Furthermore, as illustrated in FIGS. 7 and 8, in the differential image P29, an area of the portion depicted in white where the differential value is large varies depending on how fast the object moves. Specifically, as illustrated in FIG. 7, in a case where the movement of the object is slow, the portion where the differential value is large has a small area, and, as illustrated in FIG. 8, in a case where the movement of the object is fast, the portion where the differential value is large has a large area.

As such, the shutter data D10 includes the information regarding the length of the exposure time, and the motion data D30 includes the information regarding the movement of the object. The information regarding the length of the exposure time and the information regarding the movement of the object are included in the shutter data D10 and the motion data D30, respectively, the length of the exposure time and the movement of the object causing images to be blurred. Therefore, the calculation unit 15 generates the image data D90, by correcting the image represented by the captured image data D20 using the learning model M, on the basis of the shutter data D10, the captured image data D20, and the motion data D30. For example, in a portion where the movement of the object is fast, an amount of correction when correcting the image blur increases, and in a portion where the movement of the object is slow, the amount of correction when correcting the image blur decreases. In this manner, the imaging device 1 is able to generate the image data D90 representing the image with reduced blur.

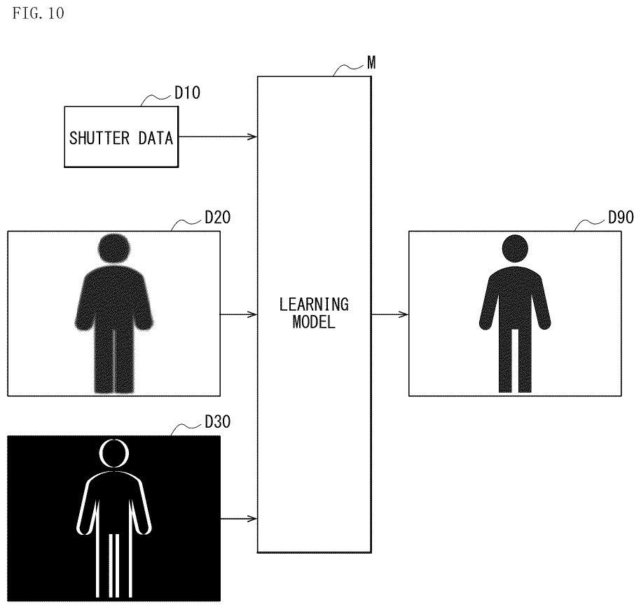

In this example, the description has been given with an example of the motion blur, but the present embodiment is not limited to this. It is also possible to apply to a case of the image blur that occurs in a case images are captured by the imaging device 1 held in hand. In this case, in captured images represented by the captured image data D20, even in a case where the object is stationary in the exposure time corresponding to the shutter speed, blur occurs because the hand holding the imaging device 1 moves. The shutter data D10 includes the information regarding the length of the exposure time, and the motion data D30 includes information regarding relative movement of the object. Therefore, as illustrated in FIG. 10, the calculation unit 15 is able to generate the image data D90 representing the image with reduced blur, by correcting the image represented by the captured image data D20 using the learning model M, on the basis of the shutter data D10, the captured image data D20, and the motion data D30.

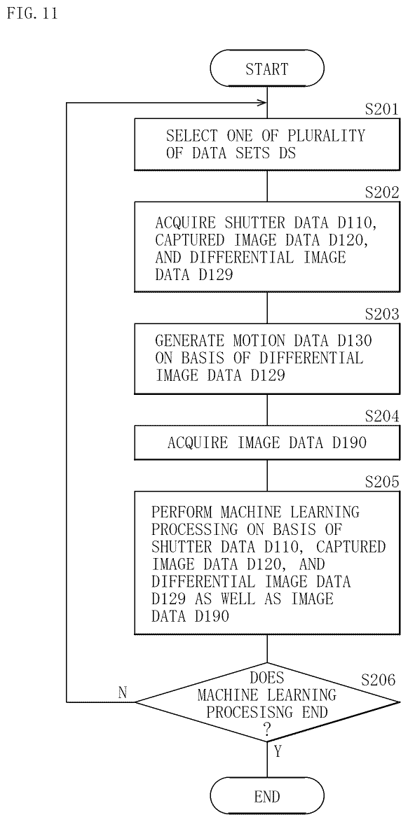

FIG. 11 illustrates an operation example of the machine learning device 100.

First, the learning processing unit 106 selects one of the plurality of data sets DS stored in the storage unit 101 (step S201).

Next, the data acquisition unit 103 acquires the shutter data D110, the captured image data D120, and the differential image data D129 that are included in a selected data set DS of the plurality of data sets DS stored in the storage unit 101 (step S202).

Next, the motion data generator 105 generates the motion data D130 on the basis of the differential image data D129 acquired in step S202 (step S203). Specifically, as illustrated in FIG. 3, the motion data generator 105 calculates, in each of the plurality of divided pixel regions R, the number of pixels having the pixel value higher than the predetermined value among the plurality of pixels in the image region R, thereby generating the motion data D130 indicating the calculation result.

Next. The teacher data acquisition unit 104 acquires the image data D190 that is included in the selected data set DS of the plurality of data sets DS stored in the storage unit 101 (step S204).

Next, the learning processing unit 106 performs the machine learning processing on the basis of the shutter data D110, the captured image data D120, and the motion data D130, as well as the image data D190 that is the teacher data (step S205).

Next, the learning processing unit 106 determines whether or not to end the machine learning processing (step S205). Specifically, the learning processing unit 106 is able to determine whether or not to end the machine learning processing by determining whether or not the learning model M has sufficiently high precision. For example, in a case where the learning processing unit 106 performs the machine learning processing on the basis of a predetermined number of data sets DS, the learning processing unit 106 may determine that the machine learning processing is to be ended. In a case where the learning processing unit 106 continues the machine learning processing (“N” in step S206), the processing returns to step S201.

In a case where the learning processing unit 106 ends the machine learning processing (“Y” in step S206), the processing ends.

In this manner, the imaging device 1 includes the imaging unit 12, the differential image generator 13, the motion data generator 14, the storage unit 16, and the calculation unit 15. The imaging unit 12 generates two captured images by performing the imaging operation at the set shutter speed at the mutually different imaging timings. The motion data generator 14 calculates, in each of the plurality of divided pixel regions R in the differential image, the number of pixels having the pixel value higher than the predetermined value among the plurality of pixels in the image region R, thereby generating the motion data D30 indicating the calculation result. The storage unit 16 stores the learning model M to which the shutter data D10 indicating the shutter speed, the captured image data D20 representing the second captured image of the two captured images, and the motion data D30 are inputted and from which the image data D90 corresponding to the captured image data D20 is outputted. The calculation unit 15 generates the image data D90 using the learning model M, on the basis of the shutter data D10, the captured image data D20, and the motion data D30. As a result, in case where an amount of blur varies in different portions of a captured image, the imaging device 1 is able to effectively reduce the blur of the image by using the motion data D30. Therefore, for example, as in the example illustrated in FIG. 2, for example, in a case where an object having a plurality of sites where motion speeds differ is included, it is possible to effectively reduce blur in each of the plurality of sites. In addition, for example, in a case where a plurality of objects is included the motion speeds of which mutually differ, it is possible to effectively reduce the blur in each of the plurality of objects.

In addition, in the imaging device 1, the motion data generator 14 calculates, in each of the plurality of divided pixel regions R in the differential image, the number of pixels having the pixel value higher than the predetermined value among the plurality of pixels in the image region R, thereby generating the motion data D30 indicating the calculation result, and the calculation unit 15 generates the image data D90 on the basis of the motion data D30. The motion data D30 has one value in each of the plurality of divided image regions R. Therefore, an amount of data of the motion data D30 is smaller than the amount of data of the captured image or the amount of data of the differential image. This makes it possible for the imaging device 1 to reduce processing load.

In addition, in this example, because the imaging device 1 performs the processing on the basis of the two captured images, it is possible to make restrictions on the exposure time, for example, fewer than a case where processing is performed on the basis of more captured images. Therefore, it is possible to increase a degree of freedom in the imaging operation. That is, in a case where many captured images are generated by repeating the imaging operation, the exposure time in each imaging operation is likely to be restricted in order to shorten a time length of an entire period of the imaging operation. In this case, the degree of freedom in the imaging operation is reduced. In this example, because the imaging device 1 performs the processing on the basis of the two captured images, such restrictions on the exposure time are fewer. Therefore, it is possible to secure the exposure time. Consequently, the imaging device 1 is able to increase the degree of freedom in the imaging operation.

In addition, the machine learning device 100 includes the data acquisition unit 103, the teacher data acquisition unit 104, the motion data generator 105, and the learning processing unit 106. The data acquisition unit 103 acquires the captured image data D120 representing one of the two captured images generated by performing the imaging operation at the set shutter speed at mutually different imaging timings, the differential image data D129 representing the differential image of the two captured images, and the shutter data D110 indicating the shutter speed. The teacher data acquisition unit 104 acquires the image data D190 corresponding to the captured image data D120. The motion data generator 105 calculates, in each of the plurality of divided pixel regions R in the differential image, the number of pixels having the pixel value higher than the predetermined value among the plurality of pixels in the image region R, thereby generating the motion data D130 indicating the calculation result. The learning processing unit 106 generates the learning model M to which the shutter data D110, the captured image data D120, and the motion data D130 are inputted and from which the image data D190 is outputted, by performing the machine learning processing using the shutter data D110, the captured image data D120, the motion data D130, and the image data D190. This makes it possible for the machine learning device 100 to generate the learning model M that is able to reduce the image blur appropriately in a case where the amount of blur varies in the different portions of the captured image.

### [Effects]

As described above, in the present embodiment, an imaging unit, a differential image generator, a motion data generator, a storage unit, and a calculation unit are included. The imaging unit generates two captured images by performing an imaging operation at a set shutter speed at mutually different imaging timings. The differential image generator generates a differential image of the two captured images. The motion data generator calculates, in each of a plurality of image regions divided in the differential image, a number of pixels having a pixel value higher than a predetermined value among a plurality of pixels in the image region, thereby generating motion data indicating a result of the calculation. The storage unit stores a learning model to which shutter data indicating the shutter speed, captured image data representing the second captured image of the two captured images, and motion data are inputted and from which image data corresponding to the captured image data is outputted. The calculation unit generates the image data using the learning model, on the basis of the shutter data, the captured image data, and the motion data. This makes it possible to effectively reduce image blur.

In the present embodiment, the motion data generator calculates, in each of a plurality of image regions divided in the differential image, a number of pixels having a pixel value higher than a predetermined value among a plurality of pixels in the image region, thereby generating motion data indicating a result of the calculation, and the calculation unit generates the image data on the basis of the motion data. This makes it possible to reduce the processing load.

In the present embodiment, it is possible to increase the degree of freedom in the imaging operation because the processing is performed on the basis of the two captured images.

In the present embodiment, a data acquisition unit, a teacher data acquisition unit, a motion data generator, and a learning processing unit are included. The data acquisition unit acquires captured image data representing one of two captured images generated by performing an imaging operation at a set shutter speed at mutually different timings, differential image data representing a differential images of the two captured images, and shutter data indicating the shutter speed. The teacher data acquisition unit acquires image data corresponding to the captured image data. The motion data generator calculates, in each of a plurality of image regions divided in the differential image, a number of pixels having a pixel value higher than a predetermined value among a plurality of pixels in the image region, thereby generating motion data indicating a result of the calculation. The learning processing unit generates the learning model to which the shutter data, the captured image data, and the motion data are inputted and from which the image data is outputted, by performing the machine learning processing using the shutter data, the captured image data, the motion data, and the image data. This makes it possible to generate a learning model that is able to effectively reduce image blur.

### Modification Example 1

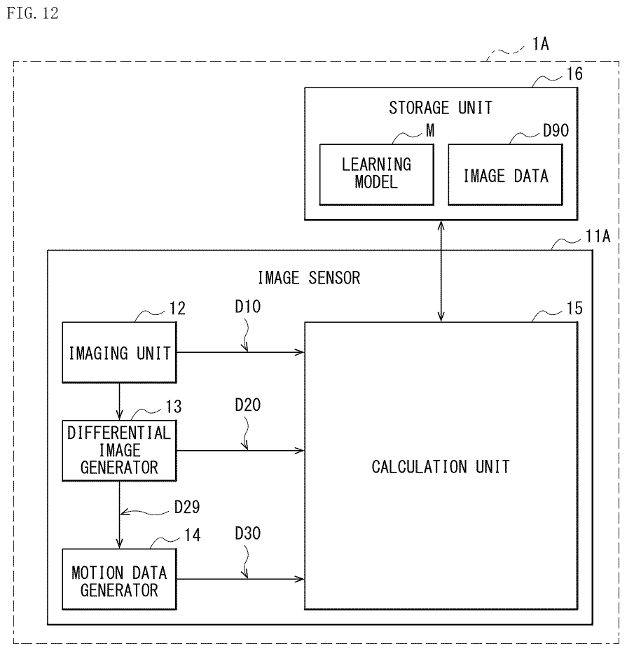

In the embodiment described above, the motion data generator 14 and the calculation unit are provided, separately from the image sensor 11, within the imaging device 1, but the present disclosure is not limited to this. Instead of this, for example, the image sensor may perform processing of the motion data generator 14 or may further perform processing of the calculation unit 15. FIG. 12 illustrates a configuration example of an imaging device 1A according to this modification example. The imaging device 1A includes an image sensor 11A. The image sensor 11A includes the imaging unit 12, the differential image generator 13, the motion data generator 14, and the calculation unit 15. In this example, the image sensor 11A generates two captured images by performing the imaging operation, generates a differential image of the two captured images, and generates the motion data D30 on the basis of the differential image data D29 representing the differential image. Then, the image sensor 11A generates the image data D90 using the learning model M, on the basis of the shutter data D10 indicating the shutter speed in the imaging operation, the captured image data D20 representing the second captured image of the two captured images, and the motion data D30.

### Modification Example 2

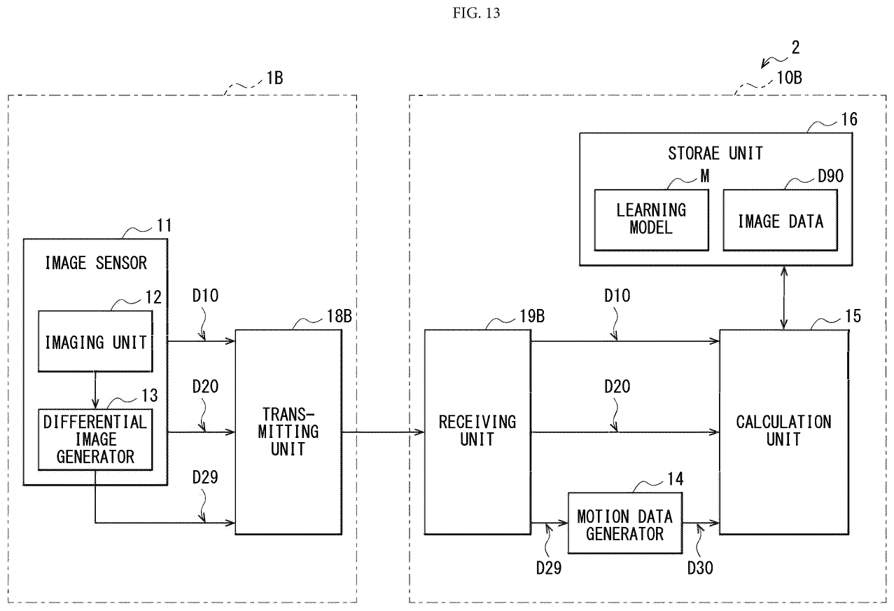

In the embodiment described above, the motion data generator 14 and the calculation unit 15 are provided within the imaging device 1, but the present disclosure is not limited to this. Instead of this, for example, the calculation unit 15 may be provided in a different device from the imaging device 1, or the motion data generator 14 may be provided in a different device from the imaging device 1. FIG. 13 illustrates a configuration example of an imaging system 2 according to this modification example. The imaging system 2 includes an imaging device 1B and a processing device 10B. The imaging device 1B includes the image sensor 11 and a transmitting unit 18B. The transmitting unit 18B is configured to transmit, to the processing device 10B, the shutter data D10 supplied from the image sensor 11, the captured image data D20, and the differential image data D29, using wired communications or wireless communications. The processing device 10B is, for example, an information processing device including a personal computer or a server device. The processing device 10B includes a receiving unit 19B, the motion data generator 14, the calculation unit 15, and the storage unit 16. The receiving unit 19B is configured to receive the shutter data D10, the captured image data D20, and the differential image data D29 that are transmitted from the transmitting unit 18B using the wired communications or wireless communications. Then, the receiving unit 19B supplies the shutter data D10 and the captured image data D20 to the calculation unit 15 and supplies the differential image data D29 to the motion data generator 14. In this example, the storage unit 16 is configured using an SSD, an HDD, or the like. Here, the imaging system 2 corresponds to a specific example of the “imaging system” in the present disclosure.

### Modification Example 3

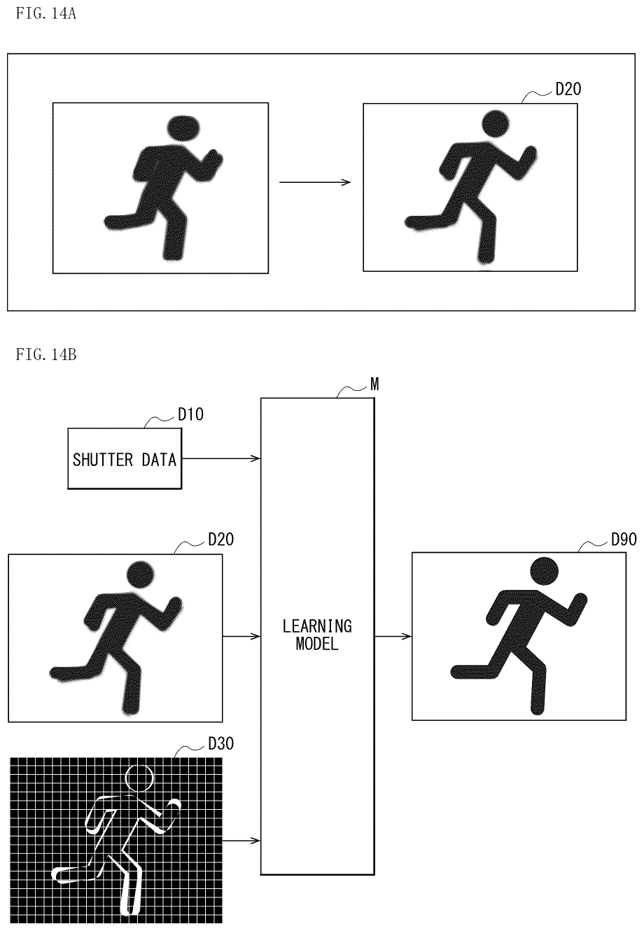

In the embodiments described above, the differential image generator 13 generates the differential image of the two captured images generated by the imaging unit 12. The imaging unit 12 may perform processing to reduce the image blur such as so-called camera shake correction, for example, when generating two captured images. The processing may be optical processing or image processing. On the basis of two captured images with reduced image blur generated by the imaging unit 12, the differential image generator 13 generates a differential image of the two captured images, and the motion data generator 14 generates the motion data D30 on the basis of the differential image data D29 represented by the differential image. Then, the calculation unit 15 generates the image data D90 using the learning model M, on the basis of the shutter data D10, the captured image data D20, and the motion data 30. FIGS. 14A and 14B each illustrate an operation example of an imaging device according to this modification example. FIG. 14A illustrates processing to reduce the image blur in the imaging unit 12, and FIG. 14B illustrates processing to generate the image data D90 in the calculation unit 15. This allows the imaging device according to this modification example to effectively reduce the image blur even in a case where there is both the image blur due to camera shake and the image blur due to object's movement.

### Modification Example 4

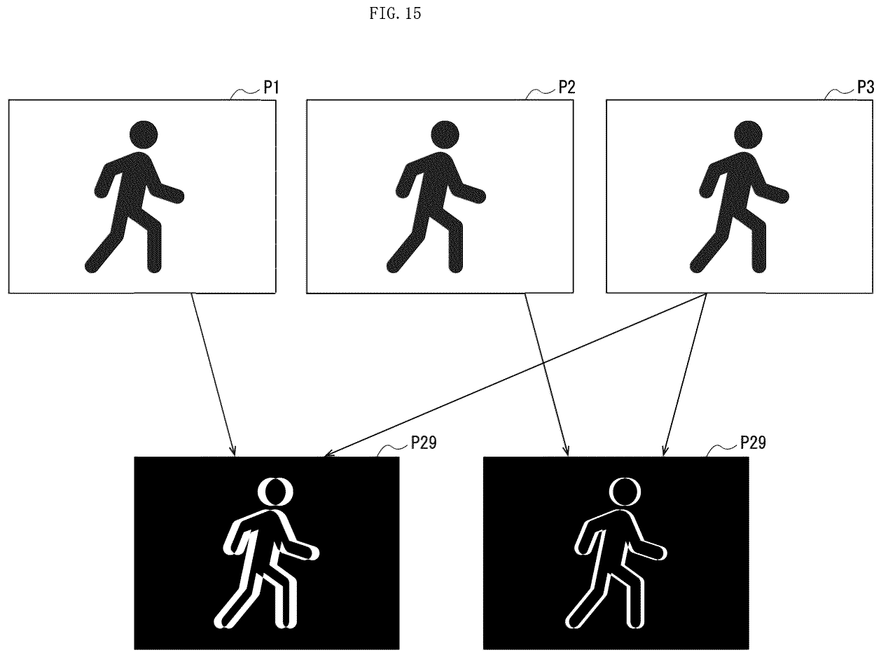

In the embodiments described above, the imaging unit 12 generates two captured images by performing the imaging operation at mutually different imaging timings, but the present disclosure is not limited to this. Instead of this, for example, the imaging unit 12 may generate three captured images as illustrated in FIG. 15. In this example, the imaging unit 12 generates the three captured images P1 to P3. The captured image P1 is generated by an imaging operation at a first imaging timing. The captured image P2 is generated by the imaging operation at a second imaging timing that is after the first imaging timing. The captured image P3 is generated by the imaging operation at a third imaging timing that is after the second imaging timing. The differential image generator 13 selects two captured images from the three captured images P1 to P3, and generates a differential image of the selected two captured images.

For example, in a case where the amount of correction is increased when correcting the image blur, the differential image generator 13 selects the captured images P1 and P3, and generates a differential image P29 of the two captured images P1 and P3. In this case, time between the imaging timings of the captured images P1 and P3 is long, and thus an amount of movement of the object in the captured images P1 and P3 is large. As a result, a white portion has a large area. The motion data generator 14 generates the motion data D30 on the basis of such a differential image P29. The calculation unit 15 generates the image data D90 using the learning model M, on the basis of the shutter data D10 and the captured image data D20 supplied from the image sensor 11 and the motion data D30 supplied from the motion data generator 14. In this example, because the white portion in the differential image P29 has a large area, it is possible to increase the amount of correction of the image blur.

For example, in a case where the amount of correction is decreased when correcting the image blur, the differential image generator 13 selects the captured images P2 and P3, and generates a differential image P29 of the two captured images P2 and P3. In this case, time between the imaging timings of the captured images P2 and P3 is short, and thus the amount of movement of the object in the captured images P2 and P3 is small. As a result, the white portion has a small area. The motion data generator 14 generates the motion data D30 on the basis of such a differential image P29. The calculation unit 15 generates the image data D90 using the learning model M, on the basis of the shutter data D10 and the captured image data D20 supplied from the image sensor 11 and the motion data D30 supplied from the motion data generator 14. In this example, because the white portion in the differential image P29 has a small area, it is possible to reduce the amount of correction of the image blur.

The differential image generator 13 selects two captured images from the three captured images P1 to P3, for example, on the basis of a user operation, and generates a differential image of the selected two images. For example, in a case where a user performs an operation to increase the amount of correction, the differential image generator 13 selects the captured images P1 and P3. For example, in a case where the user performs an operation to reduce the amount of correction, the differential image generator 13 selects the captured images P2 and P3.

### Modification Example 5

In the embodiments described above, the shutter data D110, the captured image data D120, and the motion data D130 are inputted to the learning model M, but the present disclosure is not limited to this. Instead of this, for example, imaging interval data indicating an imaging interval between two imaging timings related to two captured images may be further inputted. In the following, a detailed description will be given of this modification example.

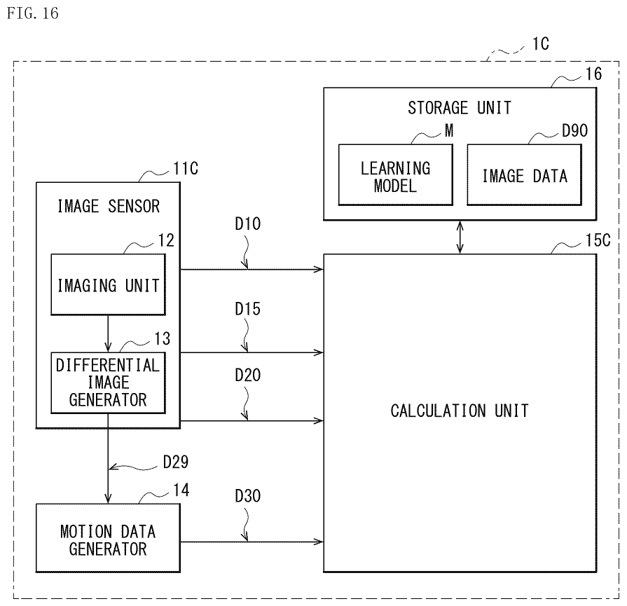

FIG. 16 illustrates a configuration example of an imaging device 1C according to this modification example. The imaging device 1C includes an image sensor 11C and a calculation unit 15C.

Similarly to the image sensor 11 according to the embodiment described above, the image sensor 11C images an object. Then, the image sensor 11C supplies, to the calculation unit 15C, the shutter data D10 indicating the shutter speed in the imaging operation, imaging interval data D15 indicating the imaging interval between the two imaging timings related to the two captured images, and the captured image data D20 representing the second captured image of the two captured images. The image sensor 11C also supplies, to the motion data generator 14, the differential image data D29 representing the differential image P29 generated by the differential image generator 13.

The calculation unit 15C is configured to generate the image data D90 using the learning model M, on the basis of the shutter data D10 and the imaging interval data D15, and the captured image data D20 supplied from the image sensor 11C as well as the motion data D30 supplied from the motion data generator 14.

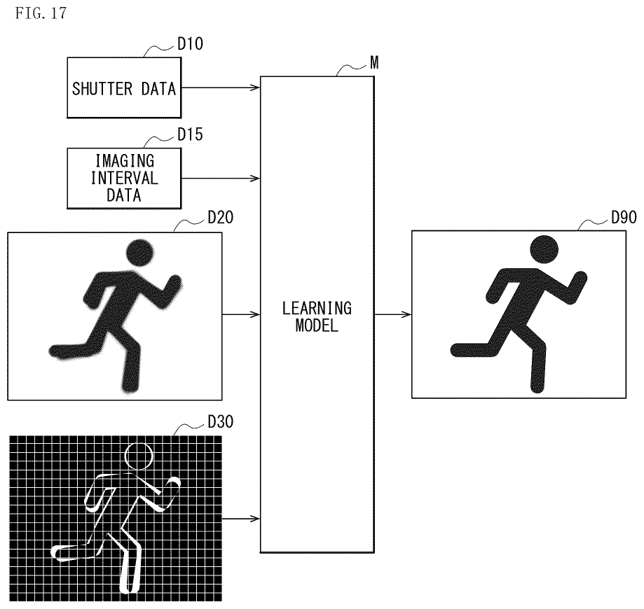

FIG. 17 illustrates an example of input data and output data of the learning model M. In this example, the learning model M is such configured that the shutter data D10, the imaging interval data D15, the captured image data D20, and the motion data 30 are inputted to the learning model M and the image data D90 is outputted from the learning model M.

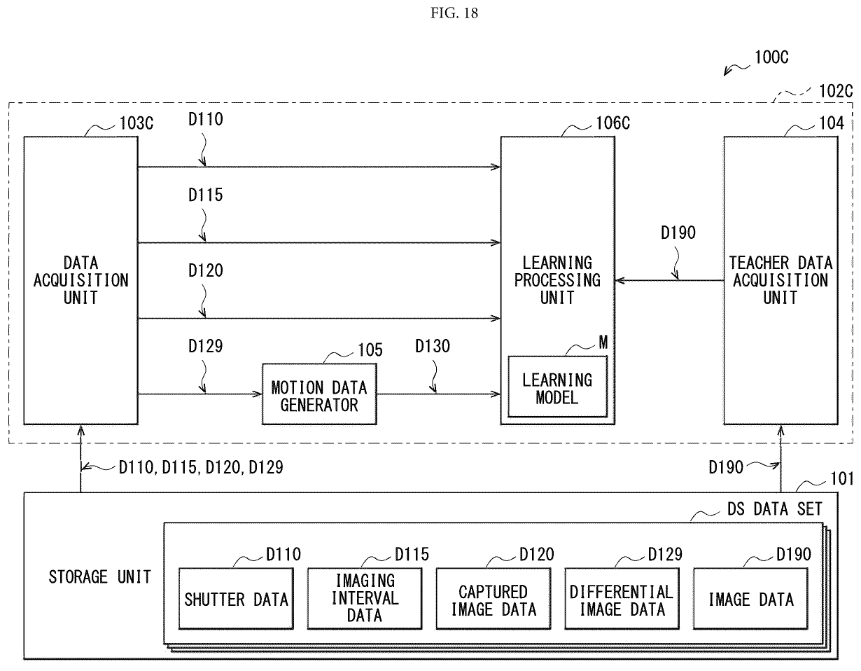

FIG. 18 illustrates a configuration example of a machine learning device 100C according to this modification example. The machine learning device 100C includes the storage unit 101 and a processing unit 102C.

The storage unit 101 stores the plurality of data sets DS. Each of the plurality of data sets DS includes the shutter data D110, imaging interval data D115, the captured image data D120, the differential image data D129, and the image data D190. Similarly to the imaging interval data D15, the imaging interval data D115 is data indicating the imaging interval between the two imaging timings related to the two captured images.

The processing unit 102C includes a data acquisition unit 103C and a learning processing unit 106C.

The data acquisition unit 103C is configured to acquire the shutter data D110, the imaging interval data D115, the captured image data D120, and the differential image data D129 that are included in the selected data set DS of the plurality of data sets DS stored in the storage unit 101. Then, the data acquisition unit 103 supplies the shutter data D110, the imaging interval data D115, and the captured image data D120 to the learning processing unit 106C, and supplies the differential image data D129 to the motion data generator 105.

The learning processing unit 106C is configured to generate the learning model M by performing the machine learning processing on the basis of the shutter data D110, the imaging interval data D115, the captured image data D120, and the motion data D130, as well as the image data D190 that is the teacher data.

Here, the imaging device 1C corresponds to a specific example of the “imaging system” in the present disclosure. The calculation unit 15C corresponds to a specific example of the “calculation unit” in the present disclosure. The imaging interval D15 corresponds to a specific example of the “imaging interval data” in the present disclosure.

The machine learning device 100C corresponds to a specific example of the “machine learning device” in the present disclosure. The data acquisition unit 103C corresponds to a specific example of the “data acquisition unit” in the present disclosure. The imaging interval D115 corresponds to a specific example of the “imaging interval data” in the present disclosure.

The imaging device 1C is able to effectively reduce the image blur even in a case where the imaging interval related to the two captured images is changed. Therefore, the imaging device 1C is able to increase the degree of freedom in the imaging operation.

### Other Modification Examples

In addition, two or more of the modification examples may be combined.

### 2. Application Example

In the following, a description will be given of an application example of any of the imaging devices described in the embodiments and the modification examples described above.

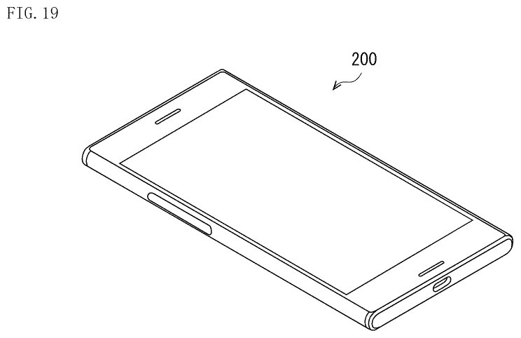

FIG. 19 illustrates appearance of a smartphone 200 to which the imaging device according to any of the above embodiments and the like is applied. The smartphone 200 includes an image sensor, a processor, a RAM, a flash memory, and the like. By the image sensor performing an imaging operation, the smartphone 200 generates a captured image and stores the generated image in the flash memory. Application of the imaging device according to any of the above embodiments and the like to such a smartphone 200 allows for the smartphone 200 to reduce the image blur.

It is possible to apply the captured images according to the above embodiments and the like to various electronic devices that perform an imaging operation, such as tablet terminals, cameras, or the like, in addition to such a smartphone.

Although the present technology has been described above with reference to some embodiments and modification examples as well as the application example to the electronic devices, the present technology is not limited to the embodiments or the like and various modifications are possible.

For example, in each of the embodiments described above, the image sensor 11 supplies, to the calculation unit 15, the second captured image of the two captured images as the captured image data D20, but the present disclosure is not limited to this. Instead of this, for example, the image sensor 11 may supply, to the calculation unit 15, the first captured image of the two captured images as the captured image data D20. In this case, it is possible for the captured image data D120 stored in the storage unit 101 of the machine learning device 100 to be data representing the first captured image of the two captured images, for example.

It is to be noted that effects described herein are merely exemplary and are not limiting, or there may be other effects as well.

It is to be noted that the present technology may have the following configurations. According to the present technology having the following configurations, it is possible to effectively reduce the image blur.

(1)

An imaging system including:
an imaging unit that is configured to generate two captured images by performing an imaging operation at a set shutter speed at mutually different imaging timings;
an image processing unit that is configured to generate a differential image of the two captured images;
a first generator that calculates, in each of a plurality of image regions divided in the differential image, a number of pixels having a pixel value higher than a predetermined value among a plurality of pixels in the image region, and is thereby configured to generate map data indicating a result of such calculation;
a storage unit that is configured to store a learning model to which shutter data indicating the shutter speed, captured image data representing one of the two captured images, and the map data are inputted and from which image data corresponding to the captured image data is outputted; and
a calculation unit that is configured to generate the image data using the learning model, on the basis of the shutter data, the captured image data, and the map data.
   (2)

The imaging system according to (1), in which
the imaging unit is configured to generate the two captured images by performing the imaging operation at predetermined time intervals,
imaging interval data indicating the predetermined time intervals is further inputted to the learning model, and
the calculation unit is configured to generate the image data using the learning model, on the basis of the shutter data, the imaging interval data, the captured image data, and the map data.
   (3)

The imaging system according to (1) or (2), in which the imaging unit is configured to generate the two captured images by performing processing to reduce image blur.

(4)

The imaging system according to any of (1) to (3), in which
the imaging unit is configured to generate a first captured image by performing the imaging operation at a first imaging timing, is configured to generate a second captured image by performing the imaging operation at a second imaging timing that is after the first imaging timing, and is configured to generate a third captured image by performing the imaging operation at a third imaging timing that is after the first imaging timing, and
the image processing unit is configured to select, as the two captured images, the second captured image and the third captured image or the first captured image and the third captured image, and is configured to generate the differential image of the selected two captured images.
   (5)

The imaging system according to any of (1) to (4), in which an image represented by the image data includes an image corrected on the basis of an image represented by the captured image data.

(6)

A processing device including:
a first generator that calculates, in each of a plurality of image regions divided in a differential image of two captured images, a number of pixels having a pixel value higher than a predetermined value among a plurality of pixels in the image region, and is thereby configured to generate map data indicating a result of such calculation, the two captured images being generated by performing an imaging operation at a set shutter speed at mutually different imaging timings;
a storage unit that is configured to store a learning model to which shutter data indicating the shutter speed, captured image data representing one of the two captured images, and the map data are inputted and from which image data corresponding to the captured image data is outputted; and
a calculation unit that is configured to generate the image data using the learning model, on the basis of the shutter data, the captured image data, and the map data.
   (7)

A machine learning device including:
a data acquisition unit that is configured to acquire captured image data, differential image data, and shutter data, the captured image data representing one of two captured images generated by performing an imaging operation at a set shutter speed at mutually different imaging timings, the differential image data representing a differential image of the two captured images, and the shutter data indicating the shutter speed;
a teacher data acquisition unit that is configured to acquire image data corresponding to the captured image data;
a second generator that calculates, in each of a plurality of image regions divided in the differential image, a number of pixels having a pixel value higher than a predetermined value among a plurality of pixels in the image region, on the basis of the differential image data, and is thereby configured to generate map data indicating a result of such calculation; and
a learning processing unit that is configured to generate a learning model to which the shutter data, the captured image data, and the map data are inputted and from which the image data is outputted, by performing machine learning processing using the shutter data, the captured image data, the map data, and the image data.
   (8)

The machine learning device according to (7), in which
the two captured images are generated by performing the imaging operation at the predetermined time intervals,
imaging interval data indicating the predetermined time intervals is further inputted to the learning model, and
the learning processing unit is configured to generate the learning model by performing the machine learning processing using the shutter data, the imaging interval data, the captured image data, the map data, and the image data.

This application claims the benefits of Japanese Priority Patent Application JP2021-151822 filed with the Japan Patent Office on Sep. 17, 2021, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An imaging system comprising:
an imaging unit that is configured to generate two captured images by performing an imaging operation at a set shutter speed at mutually different imaging timings;
an image processing unit that is configured to generate a differential image of the two captured images;
a first generator that calculates, in each of a plurality of image regions divided in the differential image, a number of pixels having a pixel value higher than a predetermined value among a plurality of pixels in the image region, and is thereby configured to generate map data indicating a result of such calculation;
a storage unit that is configured to store a learning model to which shutter data indicating the shutter speed, captured image data representing one of the two captured images, and the map data are inputted and from which image data corresponding to the captured image data is outputted; and
a calculation unit that is configured to generate the image data using the learning model, on a basis of the shutter data, the captured image data, and the map data.

2. The imaging system according to claim 1, wherein
the imaging unit is configured to generate the two captured images by performing the imaging operation at predetermined time intervals,
imaging interval data indicating the predetermined time intervals is further inputted to the learning model, and
the calculation unit is configured to generate the image data using the learning model, on a basis of the shutter data, the imaging interval data, the captured image data, and the map data.

3. The imaging system according to claim 1, wherein the imaging unit is configured to generate the two captured images by performing processing to reduce image blur.

4. The imaging system according to claim 1, wherein
the imaging unit is configured to generate a first captured image by performing the imaging operation at a first imaging timing, is configured to generate a second captured image by performing the imaging operation at a second imaging timing that is after the first imaging timing, and is configured to generate a third captured image by performing the imaging operation at a third imaging timing that is after the first imaging timing, and
the image processing unit is configured to select, as the two captured images, the second captured image and the third captured image or the first captured image and the third captured image, and is configured to generate the differential image of the selected two captured images.

5. The imaging system according to claim 1, wherein an image represented by the image data comprises an image corrected on a basis of an image represented by the captured image data.

6. A processing device comprising:
a first generator that calculates, in each of a plurality of image regions divided in a differential image of two captured images, a number of pixels having a pixel value higher than a predetermined value among a plurality of pixels in the image region, and is thereby configured to generate map data indicating a result of such calculation, the two captured images being generated by performing an imaging operation at a set shutter speed at mutually different imaging timings;
a storage unit that is configured to store a learning model to which shutter data indicating the shutter speed, captured image data representing one of the two captured images, and the map data are inputted and from which image data corresponding to the captured image data is outputted; and
a calculation unit that is configured to generate the image data using the learning model, on a basis of the shutter data, the captured image data, and the map data.

7. A machine learning device comprising:
a data acquisition unit that is configured to acquire captured image data, differential image data, and shutter data, the captured image data representing one of two captured images generated by performing an imaging operation at a set shutter speed at mutually different imaging timings, the differential image data representing a differential image of the two captured images, and the shutter data indicating the shutter speed;
a teacher data acquisition unit that is configured to acquire image data corresponding to the captured image data;
a second generator that calculates, in each of a plurality of image regions divided in the differential image, a number of pixels having a pixel value higher than a predetermined value among a plurality of pixels in the image region, on a basis of the differential image data, and is thereby configured to generate map data indicating a result of such calculation; and
a learning processing unit that is configured to generate a learning model to which the shutter data, the captured image data, and the map data are inputted and from which the image data is outputted, by performing machine learning processing using the shutter data, the captured image data, the map data, and the image data.

8. The machine learning device according to claim 7, wherein
the two captured images are generated by performing the imaging operation at the predetermined time intervals,
imaging interval data indicating the predetermined time intervals is further inputted to the learning model, and
the learning processing unit is configured to generate the learning model by performing the machine learning processing using the shutter data, the imaging interval data, the captured image data, the map data, and the image data.
